(19) United States
(12) Patent Application Publication
(10) Pub. No.: US 2020/0230854 A1
(43) Pub. Date: Jul. 23, 2020

(54) ADHESIVE AND METHOD OF BONDING TO RIGID SUBSTRATES

(71) Applicant: LORD Corporation, Cary, NC (US)

(72) Inventors: Tarek AGAG, Erie, PA (US); Brian CARNEY, Erie, PA (US); Paul WHEELER, Erie, PA (US); Andrew HEIDENREICH, Apex, NC (US); Dodik KURNIAWAN, Nagoya-shi (JP); Rebecca COWLES, Wattsburg, PA (US); Douglas MOWREY, Titusville, PA (US)

(21) Appl. No.: 16/486,249

(22) PCT Filed: Feb. 20, 2018
(86) PCT No.: PCT/US2018/018710

§ 371 Date: Aug. 15, 2019

Related U.S. Application Data
(60) Provisional application No. 62/460,914, filed on Feb. 20, 2017.
(60) Provisional application No. 62/460,910, filed on Feb. 20, 2017.
(60) Provisional application No. 62/460,912, filed on Feb. 20, 2017.

(51) Int. Cl. B29C 45/14; C09J 151/06; C09J 163/00; C09J 137/00

(52) U.S. Cl. CPC B29C 45/14311; C09J 151/06; B29C 2043/188; C09J 137/00; C09J 163/00

(57) ABSTRACT

An adhesive and method for injection or compression bonding, where the adhesive is based on a grafted polypropylene resin and at least one of maleimide compound, phenolic resin, blocked isocyanate, functionalized silane, or an epoxy resin.

### CROSS REFERENCE TO RELATED APPLICATIONS

The present application claims priority under 35 U.S.C. § 119(e) from U.S. Provisional Patent Application Ser. No. 62/460,912 filed Feb. 20, 2017, entitled “BENZOXAZINE RESIN BASED ADHESIVE”, U.S. Provisional Patent Application Ser. No. 62/460,914 filed Feb. 20, 2017, entitled “SILANE-BASED ADHESIVE FOR BONDING NYLON TO ALUMINUM”, and U.S. Provisional Patent Application Ser. No. 62/460,910 filed Feb. 20, 2017, entitled “BENZOXAZINE AND EPOXY RESIN BASED ADHESIVE”, the disclosures of which are incorporated herein by reference.

### FIELD OF THE INVENTION

The invention relates to an adhesive composition and related methods particularly suitable for injection or compression molding operations, preferably those bonding thermoplastic materials to rigid substrates.

### BACKGROUND OF THE INVENTION

There are many ways to join similar substrates such as plastic to plastic or metal to metal parts. However, there are many challenges when joining dissimilar substrates such as plastic or rubber to metals because of the difference in surface chemistries of the substrates. Bonding high-performance thermoplastics and metals to build hybrid-materials of plastic and metal would provide the best characteristics of both plastic and metal, including light weight, high strength, temperature resistance and cost-efficient production. Such adhesive systems will find tremendous application opportunities not only in auto-making and aerospace industries but also electronics, medical devices and energy and appliances assembling.

Adhesive technology has been increasingly moving away from heavy use of volatile organic solvents (VOCs) to water-borne systems. This trend is motivated by cost, safety, government regulations, and environmental concerns. Water-borne epoxy, urethane, phenolic, alkyd, and other resins are widely available on the marketplace, however they are not particularly well suited for bonding nylon and other moldable substrates to aluminum and similar rigid substrates in an in-mold bonding process.

It is to these perceived needs that the present invention is directed.

### SUMMARY OF THE INVENTION

In a first embodiment of the present invention, a novel combination of adhesive chemistry, application and process conditions is provided. As discussed above, prior art assembly conditions for plastic to rigid substrates (metal, glass, plastics, etc) utilize either mechanical means or structural adhesives and are built per the piece. An embodiment of the present invention, allows for a precision application of adhesive to the substrate surface, coupled with an injection molding process.

The adhesives described herein are particularly useful to bond two dissimilar substrates in compression and injection molding processes. For this reason, one substrate will commonly be referred to as the “liquid introduced substrate” and the other substrate will commonly be referred to as the “rigid substrate”. As such, the liquid introduced substrate is not necessarily a “liquid” but rather the conformable/deformable substrate that is introduced into the molding chamber, in contrast to the solid substrate which is remains relatively dimensionally stable during the molding operation. In an embodiment of the present invention employing an injection molding operation, the liquid introduced substrate will be a flowable liquid, such as a liquid silicone rubber. However, in embodiments of the invention employing a compression molding operation, the liquid introduced substrate may be a sold, but is compressed/deformed during the molding process to engage the solid substrate, with an adhesive disposed at least partially there between. Examples of liquid introduced substrates include liquid silicone rubber, polybutylene terephthalate, thermoplastic urethanes, castable urethanes and the like. Examples of rigid substrates include metals such as stainless steel and aluminum, nylon, polycarbonate, and other rigid plastics.

In a first embodiment of the present invention a method for bonding at least two substrates in an injection or compression molding process is provided comprising: a) selecting a rigid substrate; b) selecting a liquid introduced substrate; c) providing a curable adhesive comprising a grafted polypropylene and at least one other resin material; d) coating the rigid substrate with the curable adhesive and allowing the curable adhesive to dry; e) inserting the coated rigid substrate into an injection or compression molding machine; f) inserting the liquid introduced substrate into the compression molding machine; and, g) heating the substrates and adhesive for a period of time and at a temperature sufficient to cure the adhesive and bond the liquid introduced substrate to the rigid substrate.

In one embodiment of the present invention, the grafted polypropylene comprises a maleic anhydride grafted polypropylene. In another embodiment, the at least one other resin material comprises at least one of a benzoxazine resin, maleimide compound, phenolic resin, blocked isocyanate, functionalized silane, or an epoxy resin. In benzoxazine containing embodiments, the benzoxazine preferably comprises a bisphenol-based or diamine-based benzoxazine. In an epoxy resin containing embodiment of the present invention, the epoxy resin preferably comprises a bisphenol A based epoxy resin.

In another embodiment of the present invent, the at least one other resin material in the adhesive comprises a functional silane, and preferably at least one of an amino, polyamino, amido, aldehyde, acrylate, anhydride, aromatic, carboxylate, isocyanato, epoxy, ester, hydroxyl, methacryloxy, olefin, phosphine, phosphate, sulfur, mercapto, urethane, ureido and or vinyl functional silane, or combinations thereof.

In an additional embodiment of the present invention, the ratio of the at least one other resin material to functionalized polypropylene is about 15:85 to about 30:70, and preferably about 20:80.

In an alternate embodiment of the present invention, the curable adhesive comprises a benzoxazine resin and a film former, wherein the film former comprises at least one of polyurethane thermoplastics, polyureas, chlorinated polyolefins such as chlorinated polypropylene or chlorinated polyethylene, polystyrene copolymers such as polystyrene-grafted-maleic anhydride, polyesters, polyethers, polyamides, cellulose polymers such as hydroxyethylcellulose, or polyvinyl butyral.

In a preferred embodiment of the present invention, the adhesive comprises a grafted polypropylene, preferably maleic anhydride grafted polypropylene (95.24 parts by weight wet=19.048 parts dry) and a silane, preferably glycidoxypropyltrimethoxysilane (4.76 parts by weight wet and 4.75 parts dry). In another preferred embodiment of the present invention, the silane comprises a range of about 1 to about 30 weight percent of the solids in the adhesive system. In a further preferred embodiment of the present invention, the polypropylene polymer comprises about 70 to about 99 weight percent of the solids in the adhesive system.

In another embodiment of the present invention, the adhesive comprises a grafted polypropylene and a benzoxazine resin. In another embodiment of the present invention, the adhesive further comprises an epoxy resin and optionally an epoxy curative.

In another embodiment of the present invention, the adhesive comprises a grafted polypropylene and a silane, preferably at least one of an epoxy silane or a ureidosilane.

In a still further embodiment of the present invention, other thermoplastic resins may optionally be included in the adhesive. These thermoplastic resins comprise at least one of acrylic, polypropylene, phenoxy (including modified versions with epoxy or caprolactam functionality), polyvinyl butyral, polycarbonate, polyamide, maleic anhydride grafted thermoplastics, thermoplastic polyolefins, thermoplastic elastomers, and combinations thereof.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION OF THE INVENTION

In one embodiment of the present invention, an adhesive is provided comprising a grafted polypropylene resin. Preferably, the grafted polypropylene comprises a maleic anhydride grafted polypropylene polymer (Ma-PP) (maleic anhydride polymer with 1-butene and 1-propene). In a further embodiment of the present invention, the adhesive further comprises at least a benzoxazine resin, a maleimide compound, a polyurethane resin, a functionalized silane, such as an epoxy- or ureido-silane, or an isocyanate resin. The functionality of each allows for both a physical interaction with the liquid introduced substrate, such as a polar type plastics (polyamide, etc), coupled with chemical interaction with the rigid substrate, such as metal, glass or plastic substrates. The result is a strong chemical bonding on both the rigid substrate and the liquid introduced substrate.

In one embodiment of the present invention, the polypropylene which is a base polymer of the modified polypropylene resin is a propylene homopolymer having a melting point of higher than 130° C. and of not higher than 170° C. or a copolymer of a propylene containing not less than 93 mol % of propylene and another α-olefin. In another embodiment of the present invention, when a copolymer is used, as the other α-olefin co-monomer, there can be used ethylene, 1-butene, 1-hexene, 4-methyl-1-pentene, 1-octene or 1-decene.

As the monomer for grafting (hereinafter referred to as “grafting monomer”), there can be used an unsaturated carboxylic acid or a derivative thereof. As the unsaturated carboxylic acid, there can be concretely exemplified acrylic acid, methacrylic acid, maleic acid, fumaric acid, and itaconic acid. As the derivative of the unsaturated carboxylic acid, there can be exemplified acid anhydride, ester, amide, imide and metal salt. Concrete examples include maleic anhydride, 5-norbornane-2,3-dicarboxylic acid anhydride, itaconic anhydride, citraconic anhydride, methyl acrylate, methyl methacrylate, ethyl acrylate, ethyl methacrylate, glycidyl acrylate, monoethyl maleate ester, diethyl maleate ester, monomethyl fumarate ester, dimethyl fumarate ester, monomethyl itaconate ester, diethyl itaconate ester, acrylamide, methacrylamide, monoamide maleate, diamide maleate, N-monoethylamide maleate, N,N-diethylamide maleate, N-monobutylamide maleate, N,N-dibutylamide maleate, monoamide fumarate, diamide fumarate, N-monobutylamide fumarate, N,N-dibutylamide fumarate, maleimide, N-butylmaleimide, N-phenylmaleimide sodium acrylate, sodium methacrylate, potassium acrylate and potassium methacrylate. Among these grafted monomers, it is most desired to use maleic anhydride or 5-norbornane-2,3-dicarboxylic acid anhydride.

The preferable modified polypropylene modified with an unsaturated carboxylic acid or a derivative thereof is the one which is graft-modified with the unsaturated carboxylic acid or the derivative thereof in an amount of from 0.05 to 15% by weight and, more preferably, from 0.1 to 10% by weight based on the polypropylene of before being modified. The component of the present invention may be composed of the graft-modified polypropylene alone or may be a composition of the unmodified polypropylene and the graft-modified polypropylene.

In an alternate embodiment of the present invention, the curable adhesive comprises a functionalized polyolefin other than polypropylene. In one embodiment the functionalized polyolefin comprises a maleic anhydride, acrylic acid, or methacrylic acid grafted polyolefin. The polyolefin may comprise, for example, polyethylene, polybutadiene, and copolymers including a polyolefin such as copolymers of acrylonitrile-butadiene-styrene.

In another embodiment of the present invention, the adhesive further comprises a benzoxazine resin. Benzoxazine is composed of an oxazine ring, a heterocyclic aromatic six-membered ring with oxygen and nitrogen, attached to a benzene ring. There are several benzoxazine derivatives depending on the position of the oxygen and nitrogen in the ring. Benzoxazine resin offers tremendous performance and outstanding thermal stability as well as excellent adhesion characteristics to various substrates, including plastics and metals.

In a preferred embodiment of the present invention, the benzoxazine comprises the oxygen and nitrogen in a 1,3 configuration in the 6 membered ring. In a more preferred embodiment of the present invention, the benzoxazine comprises a bisphenol or diameine-based benzoxazine in accordance with the structures below.

Bisphenol-Based Benzoxazine:

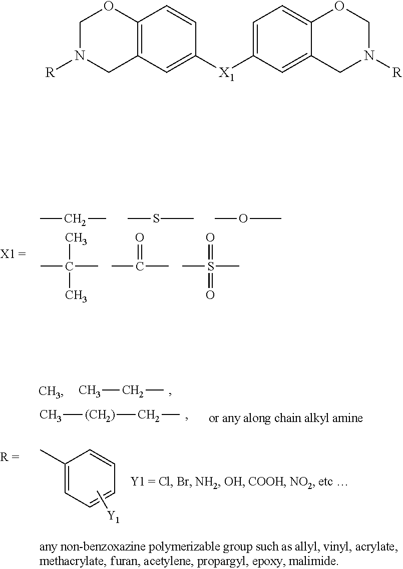

Diamine-Based Benzoxazines:

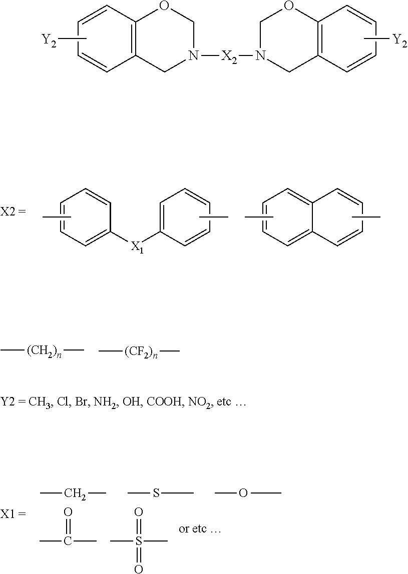

In another embodiment of the present invention, a curative for the benzoxazine resin is provided. In a most preferred embodiment of the present invention, the curative comprises an amine salt of trifluoromethanesulfonic acid. Since the benzoxazine can crosslink with the grafted resin, a separate catalyst for the grafted resin is not necessary.

In a further embodiment of the present invention, adhesion promoters, catalysts, or other materials with an affinity for bonding certain substrates are included in the adhesive formulation. As an example, in an embodiment of the present invention for bonding to polybutylene terephthalate, at least one of 4-(dimethylamino)pyridine (DMAP), or diphenyl carbonate are provided.

In an alternate embodiment of the present invention, rather than a grafted polypropylene, an alternate polymeric resin is employed as the film former in conjunction with a benzoxazine rein. Due to the versatility of benzoxazine resins, maleic anhydride grafted polypropylene is not an essential component in embodiments comprising benzoxazine. In these embodiments, other film forming resins may be used such as polyurethane thermoplastics, polyureas, chlorinated polyolefins such as chlorinated polypropylene or chlorinated polyethylene, polystyrene copolymers such as polystyrene-grafted-maleic anhydride, polyesters, polyethers, polyamides, cellulose polymers such as hydroxyethylcellulose, polyvinyl butyral, and the like.

In another embodiment of the present invention, the adhesive further comprises a maleimide compound. Maleimide containing adhesives of this embodiment are particularly useful for bonding peroxide cured adhesives. The maleimide compound comprises any compound containing at least two maleimide groups. The maleimide groups may be attached to one another or may be joined to and separated by an intervening divalent radical such as alkylene, cyclo-alkylene, epoxydimethylene, phenylene (all 3 isomers), 2,6-dimethylene-4-alkylphenol, or sulfonyl. An example of a maleimide compound wherein the maleimide groups are attached to a phenylene radical is m-phenylene bismaleimide and is available as HVA-2 from E.I. Du Pont de Nemours & Co. (Delaware, U.S.A.).

The maleimide compound crosslinker may also be an aromatic polymaleimide compound. Aromatic polymaleimides having from about 2 to 100 aromatic nuclei wherein no more than one maleimide group is directly attached to each adjacent aromatic ring are preferred. Such aromatic polymaleimides are common materials of commerce and are sold under different trade names by different companies, such as BMI-M-20 and BMI-S aromatic polymaleimides supplied by Mitsui Chemicals, Incorporated.

In a further embodiment of the present invention, the adhesive further comprises a polyester polyurethane. In one embodiment of the present invention, the polyester polyurethane comprises a silicone-modified polyester polyurethane. In another embodiment of the present invention, the silicone-modified polyester polyurethane comprises an elongation of greater than 200% when measured at a rate of 20 inches/minute (50.8 cm/min). One example of such a silicone-modified polyester-based, water-borne polyurethane dispersion is Hauthane L-2857 (available from C. L. Hauthaway & Sons Corporation, Massachusetts, U.S.A).

In another embodiment of the present invention, the adhesive further comprises an aqueous emulsion of an epoxy resin. Preferred examples of the non-ionic water emulsion of an epoxy-ester resin include, but are not limited to, multi-functional epoxy resins such as bisphenol-A based epoxy resins, bisphenol-F based epoxy resins and novolac based epoxy resins. The non-ionic aqueous epoxy-ester resin emulsion may be present in the adhesive composition in an amount of up to about 50% by weight of the dry adhesive composition, preferably not more than about 25% by weight of the dry adhesive composition.

Other suitable epoxy dispersions include EPI-REZ Resin 3510-W-60, an aqueous dispersion of a low molecular weight liquid Bisphenol A epoxy resin (EPON™ Resin 828-type); EPI-REZ Resin 3515-W-60, an aqueous dispersion of a semi-solid Bisphenol A epoxy resin; EPI-REZ Resin 3519-W-50, an aqueous dispersion of a CTBN (butadiene-acrylonitrile) modified epoxy resin; EPI-REZ Resin 3520-WY-55, an aqueous dispersion of a semi-solid Bisphenol A epoxy resin (EPON 1001-type) with an organic co-solvent; EPI-REZ Resin 3521-WY-53, a lower viscosity version of the EPI-REZ Resin 3520-WY-55 dispersion; EPI-REZ Resin 3522-W-60, an aqueous dispersion of a solid Bisphenol A epoxy resin (EPON 1002-type); EPI-REZ Resin 3535-WY-50; an aqueous dispersion of a solid Bisphenol A epoxy resin (EPON 1004-type) with an organic co-solvent; EPT-REZ Resin 3540-WY-55, an aqueous dispersion of a solid Bisphenol A epoxy resin (EPON 1007-type) with an organic co-solvent; EPI-REZ Resin 3546-WH-53, an aqueous dispersion of a solid Bisphenol A epoxy resin (EPON 1007-type) with a non HAPS co-solvent; EPI-REZ Resin 5003-W-55, an aqueous dispersion of an epoxidized Bisphenol A novolac resin with an average functionality of 3 (EPON SU-3 type); EPI-REZResin 5520-W-60, an aqueous dispersion of a urethane-modified Bisphenol A epoxy resin; EPI-REZ Resin 5522-WY-55, an aqueous dispersion of a modified Bisphenol A epoxy resin (EPON 1002-type) with an organic co-solvent; EPI-REZ Resin 6006-W-70, an aqueous dispersion of a epoxidized o-cresylic novolac resin with an average functionality of 6, each of which is commercially available from Resolution Performance Products.

In an epoxy containing embodiment of the present invention, an optional epoxy curative is provided. Preferred epoxy curatives comprise dicyandiamide, substituted ureas, blocked acid catalysts such as amine salts of p-toluenesulfonic acid, hexafluroantimony, and trifluromethane sulfonic acid, imidazoles, substituted imidazoles, or adducts of an imidazole or substituted imidazole and an epoxy resin or quaternary ammonium salts or phosphonium salts thereof, and mixtures of any of the aforesaid materials.

In another embodiment of the present invention, the adhesive comprises a silane material. In a preferred embodiment of the present invent, the silane material comprises at least one of an epoxy functional silane or a ureidosilane.

Epoxy functionally silane compounds suitable for use in the present invention include any epoxy functionalized silane compounds capable of reacting with the grafted polypropylene. Examples of suitable epoxy functional silane compounds include 3-glycidoxypropyltrimethoxysilane, 3-glycidoxypropyldimethoxysilane, 3-glycidoxypropyldimethylmethoxysilane, 2-(3,4-epoxycyclohexyl)-ethyltriemthoxysilane and the like. Such compounds are generally available commercially (for example, 3-glycidoxypropyltrimethoxysilane from Aldrich Chemical and 3-glycidoxypropyltrimethoxysilane and beta-(3,4-epoxycyclohexyl)-ethyltriemthoxysilane from Gelest Inc.) and many of such compounds are known in the literature and are obtainable by art-recognized procedures.

In another embodiment of the present invention, the silane comprises a ureidosilane. The ureidosilane materials comprise those as set forth in the following formula:

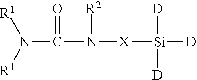

or the hydrolyzates or condensates of such silane wherein D is independently chosen from (R³) or (OR) with the proviso that at least one D is (OR). In the formula, each R is independently chosen from the group consisting of hydrogen, alkyl, alkoxy-substituted alkyl, acyl, alkylsilyl or alkoxysilyl and each R group can be linear or branched and may be the same or different. Preferably, R is individually chosen from the group consisting of hydrogen, ethyl, methyl, propyl, iso-propyl, butyl, iso-butyl, sec-butyl, and acetyl.

X in the above formula is a member selected from the group consisting of a bond, or a substituted or unsubstituted aliphatic or aromatic group. Preferably, X is selected from members of the group consisting of a bond, C₁-C₁₀ alkylene, C₁-C₆ alkenylene, C₁-C₆alkylene substituted with at least one amino group, C₁-C₆ alkenylene substituted with at least one amino group, arylene and alkylarylene.

The R¹ and R² moieties are individually selected from the group consisting of hydrogen, C₁-C₆ alkyl, cycloalkyl, C₁-C₆ alkenyl, C₁-C₆alkyl substituted with at least one amino group, C₁-C₆ alkenyl substituted with at least one amino group, arylene and alkylarylene. Preferably, R¹ is individually selected from the group consisting of hydrogen, ethyl, methyl, propyl, iso-propyl, butyl, iso-butyl, sec-butyl, ter-butyl, cyclohexyl and acetyl.

As used herein, the term “substituted” aliphatic or aromatic means an aliphatic or aromatic group wherein the carbon backbone may have a heteroatom located within the backbone or a heteroatom or heteroatom containing group attached to the carbon backbone.

R³ of the formula I is a monovalent hydrocarbon group having from 1 to 10 carbon atoms. The R³ group includes alkyl, aryl, and aralkyl groups such as methyl, ethyl, butyl, hexyl, phenyl, or benzyl. Of these, the lower C₁-C₄ alkyls are preferred. Usually R³ is methyl.

In a preferred embodiment of the present invention, the ureidosilane comprises at least one of 3-uridopropyltriethoxysilane or 3-uridopropyltrimethoxysilane.

In other embodiments of the present invention, functional silanes other than epoxy- or ureido-silanes may be employed. These silanes comprise at least one of an amino, polyamino, amido, aldehyde, acrylate, anhydride, aromatic, carboxylate, isocyanato, epoxy, ester, hydroxyl, methacryloxy, olefin, phosphine, phosphate, sulfur, mercapto, urethane, vinyl functional silane, or combinations thereof.

In one embodiment of the present invention, the adhesive further comprises a blocked isocyanate, preferably a self-blocked isocyanate. Self-blocked isocyanates are also referred to as internally-blocked isocyanates and commonly comprise dimerized diisocyanates.

Bis (cyclic ureas) are blocked aliphatic diisocyanates and are preferred in some embodiments because no by-products are formed upon thermal release of the reactive isocyanate groups. These comprise compounds that can be referred to as self-blocked isocyanates. Examples of these bis-cyclic ureas are described by Ulrich, ACS Symp. Ser. 172 519 (1981), Sherwood, J. Coat. Technol. 54 (689), 61 (1982) and Kirk-Othmer Encyclopedia of Chemical Technology, Third Edition, Volume 23, p. 584 all of which are incorporated herein by reference. As an example of such an internally-blocked isocyanate, uretdione-bound self-blocked isophorone diisocyanate, which is marketed from Huls Co. under a tradename “IPDI-BF 1540”, may be cited.

In a less preferred embodiment of the present invention, the self-blocked isocyanates comprise the dimerized diisocyanates discussed above, however there may be some isocyanate functionalities on the ends of the molecule that are partially blocked or unblocked. These functionalities may react slowly with water and decrease shelf life in aqueous formulations, however the primary “internally blocked” isocyanate functionality remains reactive in the as-applied adhesive formulation and is available for bonding.

In one embodiment of the present invention, the self-blocked isocyanate comprises dimeric isocyanates such as dimeric toluene diisocyanate (TDI-uretdione), dimeric methylene diphenyl diisocyanate (MDI-uretdione) or a mixture thereof. An example of a uretdione of MDI is GRILBOND A2BOND available from EMS-Griltech (Switzerland), and an example of a uretdione of TDI is ADOLINK TT available from Rhein Chemie Rheinau GmBH (Mannheim, Germany).

In an additional embodiment of the present invention, the isocyanate comprises a traditional blocked isocyanate. Blocked isocyanates are typically formed by the reaction of an isocyanate with either an active hydrogen or methylene compound such as malonic esters. When these blocked products are heated, the blocking agent is released and the isocyanate reacts when in the presence of an isocyanate-reactive species.

In one embodiment of the present invention, the adhesive formulations are provided in an aqueous carrier medium. In another embodiment of the present invention, the adhesive is provided in an aqueous carrier with the optional inclusion of small amounts of co-solvent. Additionally, in further embodiments of the present invent, the curable adhesive is delivered in a solvent based system. Maleic anhydride grafted polypropylene is available commercially in both solvent and aqueous systems.

In another embodiment of the present invention, additional reaction accelerators, catalysts, and/or other curing agents may be employed. For example, adhesives of the embodiment of the present invention have been prepared with imidazole-type accelerators and amine-based cure agents.

In other embodiments of the present invention, the adhesive composition may optionally comprise other well-known additives including plasticizers, fillers, pigments, surfactants, dispersing agents, wetting agents, defoamers, rheology modifiers, reinforcing agents and the like.

In embodiments of the present invention, the adhesive is provided as a “one part” or 1K formulation, wherein all the constituent materials are provided in a single mixture. In another embodiment, particularly where components may react with each other, for example when a catalyst is used, the constituents are separated into two parts, i.e. 2K. In this embodiment, typically the catalyst is separated from all of the other components, other than a carrier solvent, or at least other constituents it may react with under ambient (storage) conditions.

In a particularly preferred embodiment of the present invention, this adhesive is well suited for polyamide bonding to glass and other rigid substrates. In other embodiments of the present invention, due to the polar nature of the thermoplastic resin it is suited to applications with other polar type plastics.

In a further embodiment of the present invention, the adhesive is employed to bond to a variety of plastics and thermoplastic elastomers such as polyamides (including, but not limited to, polyamide 6, polyamide 66, polyamide 11, polyamide 12, polyamide 6T, polyamide 61, polyphthalamide), polyesters (including, but not limited to polyethylene terephthalate (PET), polybutylene terephthalate (PBT)), liquid crystalline polymer, polycarbonate (bisphenol A type), acrylonitrile-butadiene-styrene (ABS), PC/ABS blends, polyethersulfone (PES), polysulfone (PSU), polyphenyl sulfone (PPSU), polyetherimide (PEI), polyethertherketone (PEEK), polyaryletherketone (PAEK), thermoplastic elastomers such as styrene-ethylene-butylene-styrene (SEBS), polyphenylene sulfide (PPS).

The rigid substrate comprises aluminum, steel, stainless steel, glass, titanium, titanium nitride, magnesium, brass, nickel, ink-coated substrate, an assortment of the plastics listed above (polyamide, polycarbonate, ABS), and other such substrates.

The delivery or application of the above-described liquid adhesive systems can occur through multiple methods, including conventional spray, roller, brush, screen printing, stencil printing, ink printing, jet and micro spray. In a preferred embodiment of the present invention, the adhesive is typically spray applied using Binks Model 95 Siphon Spray gun. Gun is fitted with a 66SS fluid nozzle and a 66SK air cap. Atomization pressure ranged from 30-35 psi. Multiple passes are used to build the desired dry film thickness with a target range of about 25 microns. Products can be applied to substrate at varying temperatures. Typically preheating to 65° C. is preferred, but may not always be necessary or the case.

The adhesive is typically applied in a uniform wet film and hot air is employed to assist in drying and removing the carrier fluid. The dry film thickness is targeted for 1-3 mils, or 25-75 microns.

In one embodiment of the present invention, the adhesive is B-staged to produce a partially cured adhesive on the coated substrate. B-staging can occur at room temperature, generally over longer periods of time (hours), or at elevated temperatures for shorter periods of time (5-30 minutes).

Bonded assemblies are typically prepared using a compression or injection molding process. For compression molding, a mold having two separate cavities is employed. The rigid substrate having the dry adhesive film coating is placed in the preheated mold and the plastic/elastomer to be bonded is placed on top in the cavity. The hot mold is closed and placed in a hydraulic press and clamped under a known pressure. Once cured, the bonded assemblies are removed from the mold. Once the bonded assemblies cooled to room temperature they can be manually and visually tested for bond quality. Injection molding is similar, except the plastic/elastomer is injected into the mold cavity as a liquid and an elevated temperature and pressure are maintained until the assembly is cured and bonded.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### EXAMPLES

Throughout the examples, the adhesives were prepared, applied, bonded, and tested as described below, unless otherwise described in the individual example.

Adhesive Manufacture: As will be appreciated by one of skill in the art, some of the components need to be ground to a smaller particle size via bb mill, sandmill, or Kady mill, while other components can be rolled in since they are in solution or already dispersed in water as received. The adhesives were prepared according to the formulations below, and applied, bonded, cured as described below.

Adhesive Application: Typical application of the prepared adhesive is to spray apply the mixed adhesive to the rigid substrate and allowed to dry, then B-staged at 150° C. for 30 minutes before the in-mold bonding step. Dry film thickness requirements will vary but typical dry film thickness is between 25 and 75 microns or 1-3 mils.

Bonding/Curing: Bonding conditions can vary depending upon the particular processing characteristics of the liquid introduced substrate (elastomer, plastic, TPV) that is being bonded to the rigid substrate.

Testing Parameters: Typically, bond quality is tested in several manners. One such test measures the lap shear strength. In this test, two substrates are joined together in an overlap fashion, using an adhesive, with a typical adhesive area of 6.5 cm2. The lap shear specimen is then pulled apart on an Instron®-type machine at 180 degrees and a rate of 50 mm/min and force and failure mode are measured. Another such test is outlined in ASTM D429 Method B. This testing takes place using an Instron®-type test apparatus where the rigid substrate is held in place with fixturing and the liquid introduced substrate is peeled away from the substrate at an angle of 90 or 180 degrees at a speed of 30 mm/min to 300 mm/min. This method provides a value for the peeling force needed to cause two materials to separate and again the failure mode is visually examined to determine the percentage of “rubber” (non-rigid substrate) that is left on the rigid substrate.

### Failure Mode:

P=Plastic retention
AG=Adhesive to glass failure
PC=Plastic to cement failure
GB=Glass break
COH=Cohesive failure of adhesive

### Example 1

In a first example of the present invention, an adhesive is prepared comprising the formulation below. It is then used to bond a polyamide or AB/ABS to glass and aluminum substrates.

### Adhesive 1

| | Weight |
|---|---|
| Constituent | percent |
| Ma-polypropylene | 19 |
| beta-(3,4-epoxycyclohexyl)- | 4.8 |
| ethyltriemthoxysilane | |
| Methylcyclohexane | 61 |
| Methyl isobutyl ketone | 15.2 |
| Total | 100 |

In this example, the adhesive is prepared and applied to the rigid substrate and dried, then a plastic material is injection molded to the rigid substrate according to the thermoplastic resin manufactures recommendations. The parts are then tested pull tested as described above until the part is destroyed, then the failure mode is determined with the following results (average of multiple tests):

| Rigid | Injected | Pull | | | | | |
|---|---|---|---|---|---|---|---|
| Substrate | Substrate | force (N) | P | PC | AG | GB | COH |
| Glass | Fiber- | 2059 | 0 | 12% | 30% | 41% | 17% |
| | reinforced | | | | | | |
| | polyacrylamide | | | | | | |
| Aluminum | PC/ABS | 578 | 0 | 100% | 0 | 0 | 0 |
| Aluminum | PC/ABS | 574 | 0 | 100% | 0 | 0 | 0 |

### Example 2

Adhesives designated 5805-01 and 5415-15 were prepared according to the formulations below, then tested while bonding nylon to aluminum.

| | | Weight | Weight |
|---|---|---|---|
| | | Percent | Percent |
| Material | Functional Role | 5805-01 | 5415-15 |
| Benzoxazine | Primary Bonding Resin | 4.85 | 8.75 |
| Bismaleimide (M20) | Primary Bonding Resin | 4.85 | — |
| Maleic anhydride | Film former | 17.87 | 16.13 |
| grafted polypropylene | | | |
| Dapro w-77 | Wetting agent | 0.028 | 0.06 |
| Defoamer MD | Defoamer | 0.07 | 0.06 |
| Water | Carrier fluid | 72.332 | 75.0 |
| | Total: | 100 | 100 |

(Weigh percent provides dry weight of active materials, with any aqueous carrier summarized in the “water” entry)
The two adhesive systems were tested along with a 100% maleic anhydride grafted polypropylene resin for comparative purposes. All systems were bonded for 30 minutes at the temperature indicated below. All samples demonstrated cohesive failure mode with the lap shear strength as indicated in MPa:

| Adhesive | 130° C. | 170° C. |
|---|---|---|
| 5415-15 | 16.9 MPa | 17.5 MPa |
| 5805-01 | 15.0 MPa | 18.2 MPa |
| 100% Ma-PP | 3.2 MPa | 1.4 MPa |

Adhesive 5805-01 was then tested for peel strength according to ASTM D429 Method B and exhibited a peel strength of 10.5 N/m and 100% cohesive failure mode. The shear stress of the adhesives sample was then tested at different temperatures against a prior art adhesive (Chemlok® 218 adhesive available from LORD Corporation) with the results in MPa.

| Adhesive | −40° C. | 25° C. | 80° C. |
|---|---|---|---|
| 5415-15 | 13 MPa | 14 MPa | 6 MPa |
| Chemlok 218 | 4 MPa | 5 MPa | 4 MPa |

### Example 3

Adhesives designated 5265-11 and 5819-05 and 5819-06 were prepared according to the formulations below and employed to bond nylon to aluminum.

| | | Weight | Weight | Weight |
|---|---|---|---|---|
| | | Percent | Percent | Percent |
| Material | Functional Role | 5265-11 | 5819-05 | 5819-06 |
| Ureidosilane | Primary Bonding | 5.90 | 5.4 | 5.4 |
| MA-Polypropylene | Primary Bonding/ | 14.0 | 22.0 | 22.0 |
| | Film Former | | | |
| Curezol 2MA-OK | Imidazole | | 2.0 | |
| | accelerator | | | |
| Ancamine 2014AC | Amine curing agent | | | 2.0 |
| Dapro W-77 | Wetting Agent | 0.10 | 0.14 | 0.14 |
| Methanol | Co-solvent | 5.90 | 5.4 | 5.4 |
| Propylene glycol | Co-solvent | 21.46 | 10.7 | 10.7 |
| methyl ether | | | | |
| Water | Carrier fluid | 52.64 | 54.5 | 54.5 |
| | Total: | 100 | 100 | 100 |

(Weigh percent provides dry weight of active materials, with any carrier summarized in the “water” or “co-solvent” entries)

The second two adhesives were prepared with the addition of an imidazole accelerator (Curezol 2MA-OK) and an amine curing agent (Ancamine 2014AC), and each iteration evaluated under identical conditions.

The adhesives were applied by spraying to get 2 mil dry film thickness, followed by pre-baking at three different conditions. The room temp pre-bake was over four hours, while the higher temperature pre-bake cycles were 30 minutes. Samples were then tested for lap shear strength as shown below. 100° C. pre-bake condition showed the highest lap shear strength. The use of Curezol and Ancamine did not accelerate the cure under 100° C. Other additives such as Nychem 1578x1 and K-pure CXC-1615 can be added to improve the toughness and accelerate the cure.

| Adhesive | RT | 50° C. | 100° C. |
|---|---|---|---|
| 5265-11 | 8.8 MPa | 9.8 MPa | 17.1 MPa |
| 5819-05 | 7.8 MPa | 8.6 MPa | 16.4 MPa |
| 5819-06 | 8.9 MPa | 10.2 MPa | 16.0 MPa |

### Example 4

An adhesive was prepared according to the formulation below and diluted to 34.5% solids in water. It was then used to bond nylon to aluminum.

| | Dry Weight |
|---|---|
| | Percent |
| Functional Role | 6028-4 |
| Epoxy Emulsion | 19.05% |
| MA grafted | 57.14% |
| polypropylene | |
| Imidazole Curative | 4.76% |
| Benzoxazine | 19.05% |
| Total: | 100% |

(Weigh percent provides dry weight of active materials)

(Weigh percent provides dry weight of active materials)

The adhesive above was applied to aluminum coupons and allowed to dry and B-staged at various conditions, then nylon was bonded in an injection molding operation. Lap Shear strength was above 10 MPa for all B-stage conditions, including a room temperature sample that was B-staged at 25° C. for several hours.

| | 100° C. | 110° C. | 120° C. |
|---|---|---|---|
| 5 min | — | — | 10 MPa |
| 10 min | 10.5 MPa | 11 MPa | 13 MPa |
| 15 min | — | — | 14.5 MPa |
| 20 min | 12 MPa | 13.5 MPa | — |
| 30 min | 12 MPa | 12.5 MPa | — |

### Example 5

In this example, an adhesive was prepared according to the formulation below and employed to bond nylon to aluminum and stainless steel. The adhesive exhibited improved thermal shock and bonding over prior art materials.

| | % Weight | % Dry in | Actual wet |
|---|---|---|---|
| Raw Material | Solids | Formula | weight amount |
| Hauthane 2857 | 35% | 44.42 | 40.38 |
| Epoxy functional | 100% | 2.2 | 0.69 |
| silane | | | |
| Ma-PP | 33% | 50.4 | 45.68 |
| Blocked isocyanate | 20% | 3.0 | 4.57 |
| Water | | | 8.68 |

This adhesive was spray applied to 316 Stainless Steel and Aluminum coupons, then dried to a dry film thickness of 25-40 microns, and B-staged at 60° C. for 5 minutes. The coated coupons where then injection molded with polyamide according to the polyamide supplier recommendations. The bonded assemblies where then tested using a tensile test @1.3 cm/min (0.5 in/min) with the following results:

| | Aluminum | Stainless Steel |
|---|---|---|
| Primary bonding | 5.3 MPa | 6.6 MPa |
| Failure Mode | 50PC/50COH | 100 PC |

### Example 6

In this example a maleic anhydride grafted polypropylene was combined with an aqueous phenolic resin and tested to bond a number of liquid introduced substrates to glass and aluminum.

### Adhesive E1008713

Adhesive E1008713

| | % Weight | % Dry in | % Wet |
|---|---|---|---|
| Raw Material | Solids | Formula | formula |
| Ma-PP | 33% | 74.2 | 26.4 |
| Phenolic resin | 46% | 25.8 | 9.2 |
| Water | 0 | 0 | 64.4 |

The adhesive was spray applied to a dry film thickness of about 40 microns to the rigid substrate, and the polymeric substrate was injection molded according to supplier recommendations.

| | Aluminum | Glass |
|---|---|---|
| Polyaryletherketone | 4.9 MPa | — |
| Polyphenylsulfone | 4.9 MPa | — |
| Polyamide | — | 4.4 MPa |

What is claimed is:

1. A method for bonding at least two substrates in an injection or compression molding process comprising:
a) selecting a rigid substrate;
b) selecting a liquid introduced substrate;
c) providing a curable adhesive comprising a grafted polypropylene and at least one other resin material;
d) coating the rigid substrate with the curable adhesive and allowing the curable adhesive to dry;
e) inserting the coated rigid substrate into an injection or compression molding machine;
f) inserting the liquid introduced substrate into the compression molding machine; and,
g) heating the substrates and adhesive for a period of time and at a temperature sufficient to cure the adhesive and bond the liquid introduced substrate to the rigid substrate.

2. The method of claim 1, wherein the grafted polypropylene comprises a maleic anhydride grafted polypropylene.

3. The method of claim 1, wherein the at least one other resin material comprises at least one of a benzoxazine resin, maleimide compound, phenolic resin, blocked isocyanate, functionalized silane, or an epoxy resin.

4. The method of claim 3, wherein the benzoxazine comprises a bisphenol-based or diamine-based benzoxazine.

5. The method of claim 3, wherein the epoxy resin comprises a bisphenol A based epoxy resin.

6. The method of claim 5, wherein the adhesive further comprises an imidazole catalyst.

7. The method of claim 1, wherein the at least one other resin material comprises a functional silane.

8. The method of claim 1, wherein the functional silane component comprises at least one of an amino, polyamino, amido, aldehyde, acrylate, anhydride, aromatic, carboxylate, isocyanato, epoxy, ester, hydroxyl, methacryloxy, olefin, phosphine, phosphate, sulfur, mercapto, urethane, ureido and or vinyl functional silane, or combinations thereof.

9. The method of claim 8, where the functional silane comprises glycioxypropyltrimethoxysilane.

10. The method of claim 8, wherein the functional silane comprises at least one of 3-uridopropyltriethoxysilane or 3-uridopropyltrimethoxysilane.

11. The method of claim 8, further comprising a urethane resin.

12. The method of claim 1, wherein the adhesive further comprises water and optionally a co-solvent selected from propylene glycol methyl ether or methanol.

13. The method of claim 1, wherein ratio of the at least one other resin material to functionalized polypropylene is about 15:85 to about 30:70.

14. The method of claim 13, wherein the ratio of the at least one other resin material to functionalized polypropylene comprises about 20:80.

15. The method of claim 1, wherein the liquid introduced substrate comprises a polar thermoplastic material.

16. The method of claim 1, wherein the rigid substrate comprises at least one of glass, aluminum, or stainless steel.

17. The method of claim 1, wherein the liquid introduced substrate comprises at least one of polyamide, polycarbonate, or a blend of polycarbonate/acrylonitrile butadiene styrene.

18. A method for bonding at least two substrates in an injection or compression molding process comprising:
a) selecting a rigid substrate;
b) selecting a liquid introduced substrate;
c) providing a curable adhesive comprising a grafted polyolefin and at least one other resin material;
d) coating the rigid substrate with the curable adhesive and allowing the curable adhesive to dry;
e) inserting the coated rigid substrate into an injection or compression molding machine;
f) inserting the liquid introduced substrate into the compression molding machine; and,
g) heating the substrates and adhesive for a period of time and at a temperature sufficient to cure the adhesive and bond the liquid introduced substrate to the rigid substrate.

19. A method for bonding at least two substrates in an injection or compression molding process comprising:
a) selecting a rigid substrate;
b) selecting a liquid introduced substrate;
c) providing a curable adhesive comprising a benzoxazine resin and a film former;
d) coating the rigid substrate with the curable adhesive and allowing the curable adhesive to dry;
e) inserting the coated rigid substrate into an injection or compression molding machine;
f) inserting the liquid introduced substrate into the compression molding machine; and,
g) heating the substrates and adhesive for a period of time and at a temperature sufficient to cure the adhesive and bond the liquid introduced substrate to the rigid substrate.

20. The method of claim 19, wherein the film former comprises at least one of polyurethane thermoplastics, polyureas, chlorinated polyolefins such as chlorinated polypropylene or chlorinated polyethylene, polystyrene copolymers such as polystyrene-grafted-maleic anhydride, polyesters, polyethers, polyamides, cellulose polymers such as hydroxyethylcellulose, or polyvinyl butyral.

21. An adhesive comprising a benzoxazine resin and a film former.

22. The adhesive of claim 21, wherein the film former comprises at least one of polyurethane thermoplastics, polyureas, chlorinated polyolefins such as chlorinated polypropylene or chlorinated polyethylene, polystyrene copolymers such as polystyrene-grafted-maleic anhydride, polyesters, polyethers, polyamides, cellulose polymers such as hydroxyethylcellulose, or polyvinyl butyral.

23. The adhesive of claim 22, further comprising at least one of a maleimide compound, phenolic resin, blocked isocyanate, functionalized silane, or an epoxy resin.
